(19) United States
(12) Patent Application Publication
(10) Pub. No.: US 2026/0258622 A1
(43) Pub. Date: Sep. 3, 2026

(54) INFLATABLE SEVERE-WEATHER SEAWALL

(71) Applicant: Aaron Brian Leet, Oakdale, MN (US)

(72) Inventor: Aaron Brian Leet, Oakdale, MN (US)

(21) Appl. No.: 19/555,883

(22) Filed: Mar. 3, 2026

Related U.S. Application Data
(60) Provisional application No. 63/766,171, filed on Mar. 3, 2025.

(51) Int. Cl. E02B 3/10

(52) U.S. Cl. CPC E02B 3/108; E02B 3/102

(57) ABSTRACT

A deployable seawall includes a flexible wall body defining first and second elongate chambers extending along a length. The wall body defines a forward-facing hooked crescent profile configured to receive an incident wave into a concavity and cause the wave to curl beneath a lip portion and roll back on itself, and a rearward-facing lower buttress portion extending at about forty-five degrees relative to horizontal to increase support. Intersecting triangular reinforcement members form a lattice distributed throughout both chambers to maintain geometry and resist deformation under hydrostatic and hydrodynamic loading. During a severe-water event, both chambers are filled substantially completely with water to create mass for stability while a top vent discharges gas during filling. After the event, water is evacuated and the wall body is collapsed for storage or reuse. An in-ground installation may deploy the seawall responsive to an early warning input.

### PRIORITY CLAIM

The present application claims the benefit of U.S. Provisional Patent Application No. 63/766,171, filed Mar. 3^{rd}, 2025, and titled “DUNAMIS,” the entire contents of which are incorporated herein by reference.

### TECHNICAL FIELD

The present technology is generally related to relates to deployable protective barriers and, more particularly, to inflatable and ballast-fillable seawalls configured for temporary or semi-permanent protection against storm surge, hurricane-driven waves, tsunamis, and other severe-water events.

### BACKGROUND

Coastal and low-lying areas are increasingly exposed to episodic flooding caused by storm surge, extreme tides, and wave action. Conventional permanent seawalls and levees may be expensive, time-consuming to construct, and difficult to modify when local risk profiles change. Temporary barriers, including sandbags and modular rigid panels, can require substantial labor and can be logistically challenging to deploy at scale and with sufficient height and stability. Inflatable barriers have been proposed, but many such barriers struggle to simultaneously achieve rapid deployment, adequate mass and stability against hydrostatic and hydrodynamic loads, and reliable recovery and re-use after an event.

In particular, barriers that rely solely on gas inflation may be insufficiently massive and can be displaced by buoyancy, wave impact, or undermining, while barriers relying solely on water filling may be slow to raise into an effective protective configuration. Accordingly, there remains a need for a rapidly deployable wall that can be configured to manage wave energy and to provide sufficient mass and stability against hydrostatic and hydrodynamic loading, while also providing structural reinforcement, controlled venting, anchoring, and efficient post-event deflation and recovery.

### SUMMARY OF THE DISCLOSURE

In one aspect, a deployable seawall includes a flexible wall body defining at least a first elongate chamber and a second elongate chamber extending along a length of the seawall. The wall body includes a forward-facing exterior profile having a hooked crescent shape in transverse cross-section configured to receive an incident wave into a forward-facing concavity and cause the wave to curl beneath a forwardly projecting lip portion and roll back on itself, thereby dissipating energy and reducing overtopping. The wall body further includes a rearward-facing lower buttress portion extending outward at an angle of about forty-five degrees relative to horizontal in a deployed condition to add structural support and increase resistance to overturning.

In another aspect, the seawall includes reinforcement members disposed within the wall body and distributed throughout both the first elongate chamber and the second elongate chamber. The reinforcement members include intersecting triangular reinforcement members forming a lattice configured to maintain the hooked crescent profile and the rearward-facing buttress portion and to resist deformation under hydrostatic and hydrodynamic loading.

In another aspect, the first elongate chamber and the second elongate chamber are each configured to be filled substantially completely with water during a severe-water event to create mass for stability. In some examples, the seawall is initially elevated using a lifting gas and is thereafter flooded with water, with controlled venting of the lifting gas. After the event, water may be evacuated from the chambers and the wall body may be collapsed for storage and reuse.

In another aspect, the seawall may be installed in-ground or within a subsurface housing and coupled to an early warning system, such that the seawall automatically rises and deploys responsive to a trigger including a sensor input indicating approaching surge or tsunami conditions.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view of an example deployable inflatable seawall in a deployed condition along a protected boundary.

FIG. 2 is a transverse cross-sectional view of the seawall of FIG. 1 showing a hooked crescent forward-facing profile, a rearward-facing lower buttress portion extending at about forty-five degrees relative to horizontal, and first and second chambers configured to be filled substantially completely with water.

FIG. 3 is a partial cutaway view showing example internal reinforcement members, including intersecting triangular reinforcement members forming a lattice distributed throughout both chambers.

FIG. 4 is a schematic view of an example in-ground installation in which the seawall is stored below grade and rises to deploy responsive to an activation signal.

FIG. 5 is a flow diagram of an example method of deploying, operating, and recovering a water-ballasted inflatable seawall.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

The following description is presented to enable any person skilled in the art to make and use the disclosed subject matter and is provided in the context of particular examples and variations. Various modifications to the disclosed examples will be readily apparent to those skilled in the art, and the general principles described herein may be applied to other examples and applications without departing from the spirit and scope of the disclosure. Accordingly, the disclosed subject matter is not intended to be limited to the examples shown, but is to be accorded the widest scope consistent with the principles and features described herein.

As used herein, the term “seawall” includes any deployable barrier configured to impede, deflect, attenuate, or redirect water flow and wave energy, including barriers used along coastlines, riverbanks, canals, levee lines, industrial sites, and critical infrastructure perimeters.

As used herein, “ballast medium” includes water, brine, slurry, sand-water mixtures, or other pumpable liquids and liquid-solid mixtures.

As used herein, “lifting gas” includes air, oxygen, nitrogen, carbon dioxide, inert gases, or mixtures thereof.

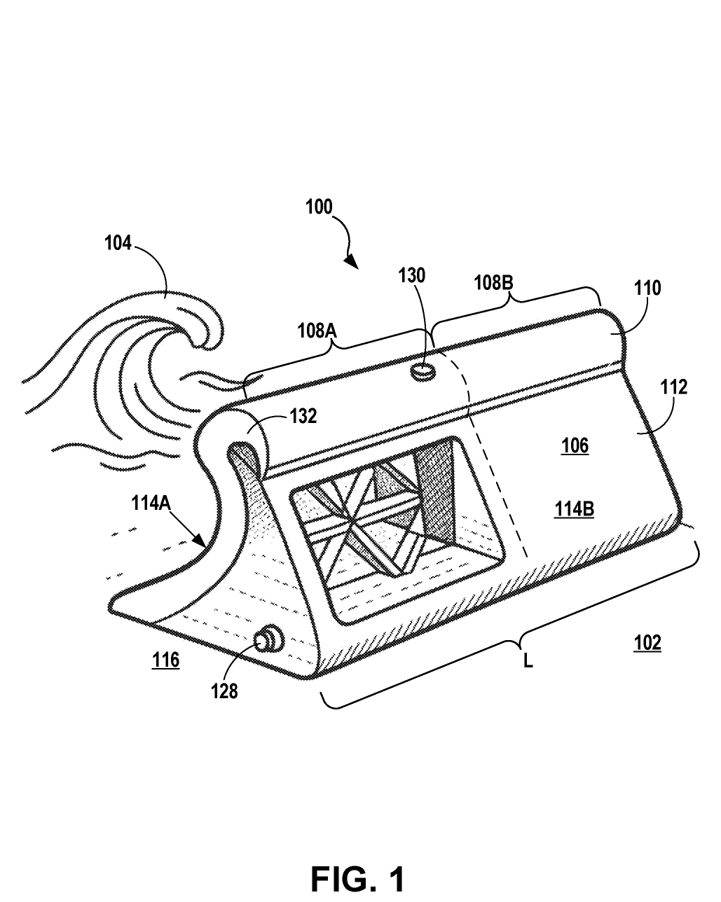

FIG. 1 illustrates an example deployable seawall 100 extending along a length “L” to protect a designated space 102 from a severe-weather condition 104. The seawall 100 includes a flexible wall body 106 formed from a high-strength reinforced sheet material. In some examples, the sheet material includes a woven, braided, laminated, or film-based composite incorporating high-strength fibers and/or nano-reinforcements. Example reinforcement materials include ultra-high-molecular-weight polyethylene fibers, aramid fibers, liquid crystal polymer fibers, carbon-based reinforcements, and other high-strength constituents. In some examples, the wall body 106 includes a reinforced geometric pattern, including a hexagonal reinforcement pattern, configured to distribute loads and resist tear propagation.

In some examples, the seawall 100 may be configured as a modular system including a plurality of discrete segments 108A/108B aligned end-to-end and mutually coupled together, e.g., via seals, clamps, zippers, heat welds, adhesive bonds, mechanical fasteners, and/or gasketed interfaces. In some examples, two or more segments 108 may be deployed and interconnected on-site to achieve a particular length “L” defined by the local terrain and other features of the surrounding geography 102.

The wall body 106 includes a top region 110 and a bottom region 112. In a deployed condition, the wall body 106 presents a forward-facing exterior portion 114A toward an incoming-water side and a rearward-facing exterior portion 114B toward a protected side. The bottom region 112 is configured to contact a ground surface 116, pavement, a foundation element, or a prepared substrate.

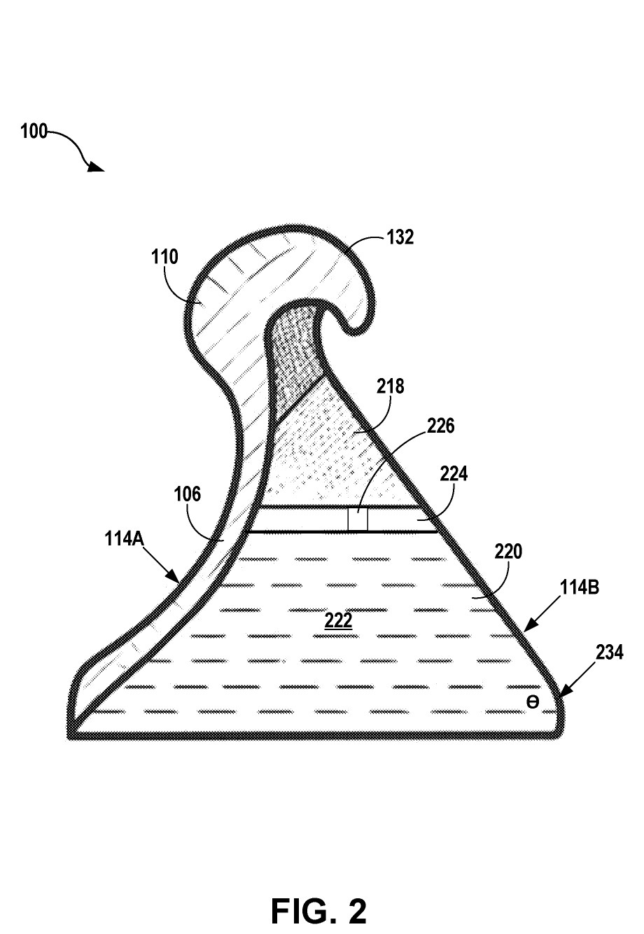

FIG. 2 illustrates that the wall body 106 defines at least a first chamber 218 and a second chamber 220. The chambers extend along the length “L” and are configured to be filled with ballast medium 222 to create mass for stability during a severe-water event 104. In some examples, the first chamber 218 and the second chamber 220 are separated by an internal partition 224, which may be integral with the wall body 106. In some examples, the chambers 218/220 are fluidly isolated to allow independent filling and independent pressure and venting control. In some examples, an interconnection valve 226 provides selective communication between chambers for equalization or controlled transfer under specified conditions.

In some examples, the seawall 100 includes one or more fill ports for introducing ballast medium 222. For example, the second chamber 220 may be fluidly coupled to a ballast inlet/outlet 128 (FIG. 1) positioned proximate the bottom region 112 to introduce ballast medium 222 and to evacuate ballast medium 222 during recovery. In some examples, the first chamber 218 includes a corresponding water fill port (not shown) positioned proximate the bottom region 112. In some examples, one or more of the ports are provided at intervals along the length L to reduce fill time and promote uniform filling.

In some examples, the first chamber 218 is also fluidly coupled to a gas inlet configured to receive a lifting gas. The gas inlet may be coupled to a compressor, a pressurized cylinder, or a gas generator. In some examples, the gas generator is a chemical or pyrotechnic inflator configured to rapidly produce gas for emergency deployment. In such examples, the gas inlet enables a “lift” phase in which the first chamber 218 is inflated with lifting gas to elevate the wall body 106 toward an operational height. After the wall body 106 is elevated, the first chamber 218 may be flooded with ballast medium so that the first chamber 218 and the second chamber 220 are each filled substantially completely with ballast medium to provide mass and stability.

The wall body 106 includes at least one vent 130 positioned proximate the top region 110. The vent 130 may include a normally-closed valve, a check valve, a pressure relief valve, or a controllable valve actuated electrically, pneumatically, hydraulically, or mechanically. During a lift phase, the vent 130 may remain closed or controlled to build pressure and raise the wall body 106. During filling with ballast medium 222, the vent 130 may be controlled to discharge gas as the ballast medium 222 rises. During recovery, the vent 130 may be opened to facilitate deflation and collapse of the wall body 106

In some examples, the forward-facing exterior portion 114A of the wall body 106 defines a hooked crescent profile in transverse cross-section. The hooked crescent profile may be characterized by a re-entrant curvature that forms a forward-facing concavity and a forwardly projecting lip portion positioned above at least part of the concavity. In use, the hooked crescent profile is configured to receive an incident wave 104 into the concavity and redirect the wave upward and inward so that the wave 104 curls beneath the lip portion and rolls back toward the source, thereby dissipating energy and reducing overtopping. The hooked crescent profile may define a wave-reversal pocket that remains open during filling and during a severe-water event due at least in part to internal reinforcement members described herein. In some examples, the lip portion is defined by an upper lobe 132 of the wall body 106 and a locally reinforced edge region configured to resist collapse of the re-entrant curvature under repeated wave impacts.

In some examples, the rearward-facing lower portion 114B of the wall body 106 forms a buttress portion 234 that extends outward from the bottom region 112 at an angle ϴ of about 45° relative to horizontal when the seawall 100 is deployed. The buttress portion 234 increases a base footprint and provides an increased resisting moment against rotation and overturning under surge and wave loading. The buttress portion 234 may be formed as a rearward projecting lobe, wedge, or inclined panel region that becomes tensioned when the chambers are filled.

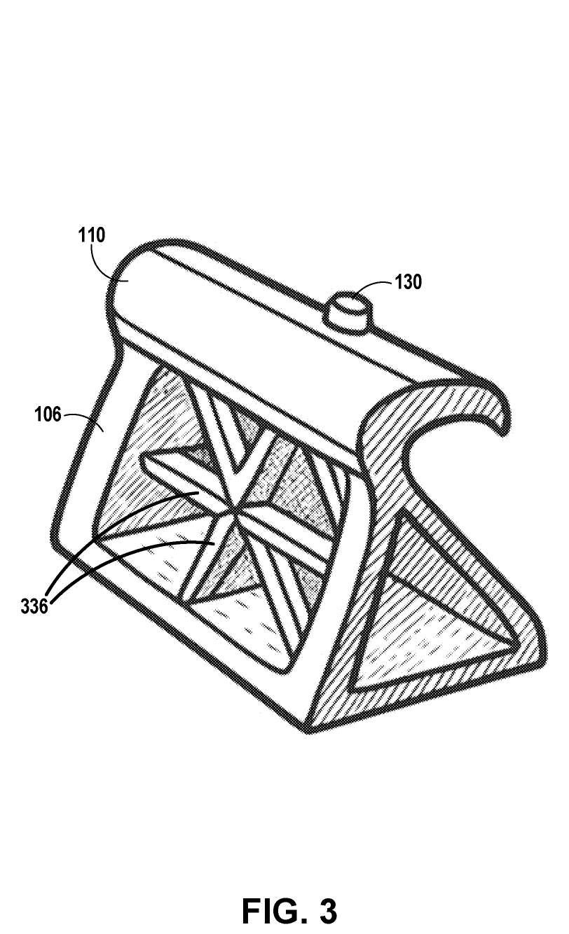

FIG. 3 illustrates example reinforcement members 336 disposed within the wall body 106. In some examples, reinforcement members 336 are distributed throughout both the first chamber 218 and the second chamber 220 and include intersecting triangular reinforcement members that cross at intersections to define a repeating triangular lattice. The lattice may extend along the length L and across at least part of a height and thickness of the wall body 106. The intersecting triangular reinforcement members 336 may be joined at intersections by stitching, welding, adhesive bonding, mechanical fastening, or integral formation. In operation, the lattice is configured to resist bulging, maintain the hooked crescent forward-facing profile 114A and the rearward-facing buttress portion 234, and provide a truss-like load path to transfer hydrostatic and hydrodynamic loads to the bottom region 112 and any anchoring features.

In some examples, the reinforcement members 336 include layered constructions to provide puncture resistance and tear resistance. In some examples, the reinforcement members 336 include localized stiffeners and/or load-spreading patches at attachment points to the wall body 106 and/or to the internal partition 224.

The seawall 100 may include anchoring and stabilization features 338. In some examples, the anchoring and stabilization features 338 include tethers coupled to the wall body 106 and configured to be secured to ground anchors, deadmen, stakes, driven piles, embedded rails, or existing infrastructure. In some examples, the bottom region 112 includes a ground-contacting skirt configured to increase friction, reduce seepage, and resist undermining. In some examples, the seawall 100 includes a base flange configured to be buried, weighted, or clamped to a foundation element.

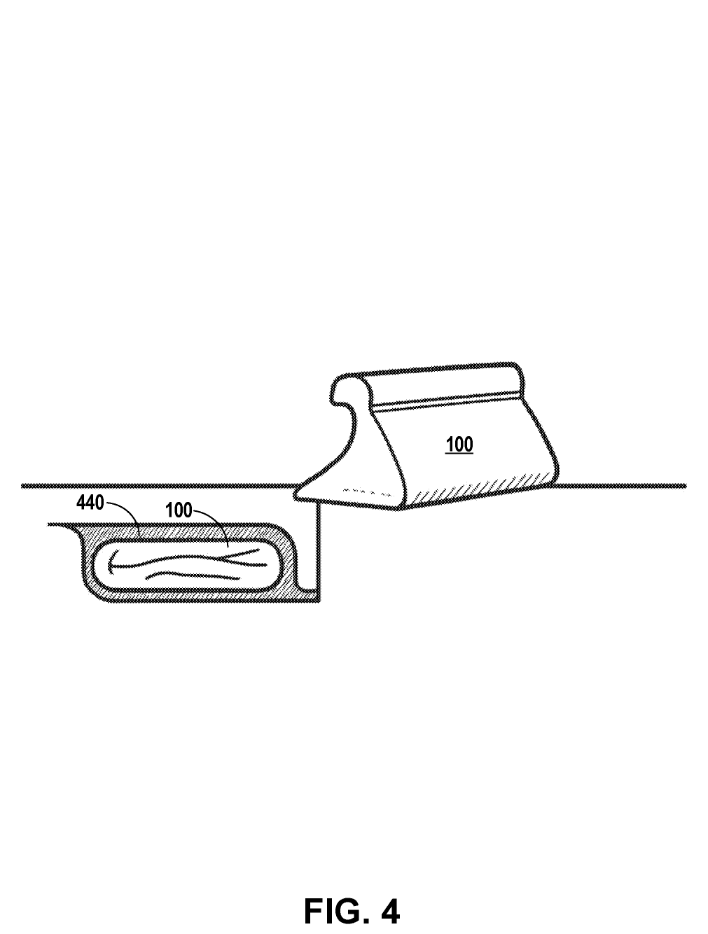

FIG. 4 illustrates an example in-ground installation. The seawall 100 may be stored below grade within a housing 440 such as a trench, vault, or elongated container. The seawall 100 may be coupled to an activation system configured to initiate deployment responsive to a trigger. The activation system may receive signals from an early warning system, including storm surge forecasts, tide gauges, pressure sensors, accelerometers, seismically driven tsunami alerts, local water-level sensors, and/or manual activation. Upon activation, the activation system may energize a gas inflator and/or compressor to inflate the first chamber 218 so the seawall 100 rises from the housing 440. The chambers 218/220 may then be filled with ballast medium 222 to provide mass and stability.

In some examples, the seawall 100 is configured for mobile deployment. The seawall 100 may be stored on a spool, folded in a container, or transported on a trailer. In some examples, the seawall 100 includes quick-connect fittings for one or more of the gas inlet, the vent 130, and the ballast inlet/outlet 128 to enable rapid field hookup. In some examples, multiple fill ports are provided at intervals along the length L to reduce fill time and promote uniform filling.

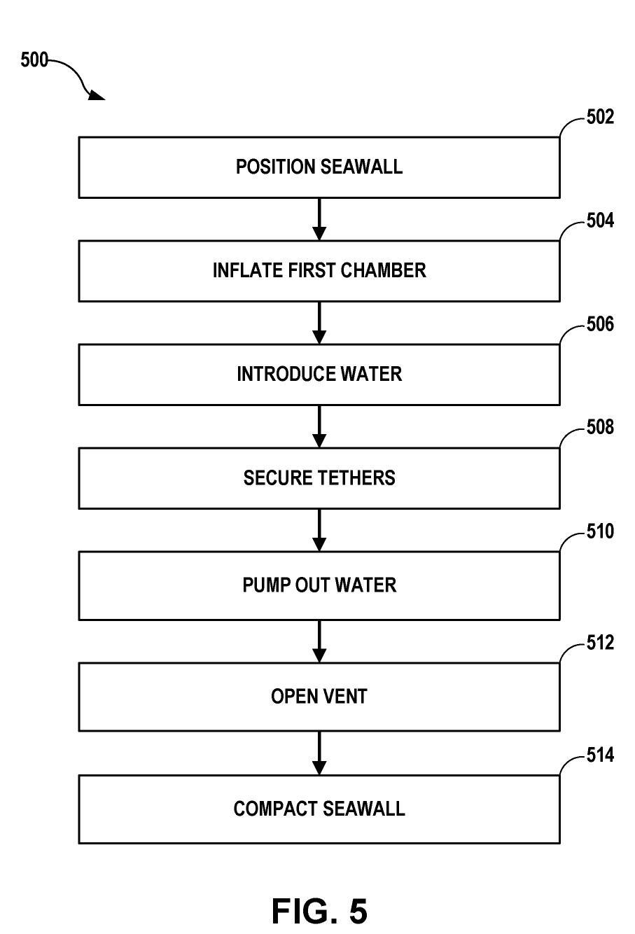

FIG. 5 illustrates an example method of use. In an example deployment, the seawall 100 is positioned along a boundary to be protected (502). In some examples, the first chamber 218 is inflated with a lifting gas to raise the wall body 106 toward an operational height while keeping the vent 130 closed or controlled (504). Water is then introduced to fill the first chamber 218 and the second chamber 220 substantially completely, while the vent 130 is controlled to discharge gas as water rises (506). The intersecting triangular reinforcement members 336 maintain the hooked crescent forward-facing profile 114A and the rearward-facing buttress portion 234 and resist deformation under hydrostatic and hydrodynamic loading. Tethers and anchors may be secured to resist lateral and uplift loads (508).

After the severe-water event 104, and after water levels recede to a recovery threshold, water is pumped out of the first chamber 218 and the second chamber 220 through one or more lower ports (510). The vent 130 may be opened to facilitate collapse of the wall body 106 (512). The seawall 100 may then be folded, rolled, or otherwise compacted for storage, removal, inspection, repair, and re-use.

Although examples have been described with two chambers, additional chambers may be used, including a multi-chamber stack providing staged filling, redundancy against puncture, and zoned venting control. Likewise, while particular reinforcement member geometries are described, other internal structures may be used in combination with the intersecting triangular reinforcement members, including straps, baffles, webs, ribs, drop-stitch structures, and composite trusses. The disclosed features may be combined in any technically compatible manner.

The techniques described herein may be implemented in hardware, software, firmware, or any suitable combination thereof. If implemented in software, the functions may be stored as instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital-signal processors (DSPs), general-purpose microprocessors, application-specific integrated circuits (ASICs), field-programmable logic arrays (FPGAs), or other equivalent integrated or discrete-logic circuitry. Accordingly, the term “processor” as used herein may refer to any of the foregoing structures or any other physical structure suitable for implementation of the described techniques, such as circuits or logic elements.

What is claimed is:

1. A deployable seawall system comprising:
a flexible wall body extending along a length and having a top region and a bottom region, the flexible wall body defining a first elongate chamber and a second elongate chamber;
one or more fill ports in fluid communication with the first elongate chamber and the second elongate chamber, respectively, the one or more fill ports configured to introduce water into the first elongate chamber and the second elongate chamber;
a vent positioned proximate the top region and configured to be selectively opened to discharge gas from at least one of the first elongate chamber and the second elongate chamber during filling with the water and to facilitate collapse during recovery;
a plurality of reinforcement members disposed within the flexible wall body and distributed throughout both the first elongate chamber and the second elongate chamber, the reinforcement members comprising intersecting triangular reinforcement members forming a lattice configured to resist deformation of the flexible wall body under hydrostatic and hydrodynamic loading;
wherein a forward-facing exterior portion of the flexible wall body defines a hooked crescent profile in transverse cross-section configured to receive an incident wave into a forward-facing concavity and cause the incident wave to curl beneath a forwardly projecting lip portion and roll back on itself; and
wherein a rearward-facing lower portion of the flexible wall body includes a buttress portion extending from the bottom region at about forty-five degrees relative to horizontal when the deployable seawall system is in a deployed condition, wherein the deployable seawall system is configured such that, during a severe-water event, the first elongate chamber and the second elongate chamber are each fillable substantially completely with the water to create mass for stability.

2. The deployable seawall system of claim 1, wherein the hooked crescent profile comprises a re-entrant curvature defining a wave-reversal pocket and the forwardly projecting lip portion overlies at least part of the wave-reversal pocket.

3. The deployable seawall system of claim 1, further comprising a gas inlet in fluid communication with the first elongate chamber, the gas inlet configured to receive a lifting gas to elevate the flexible wall body toward an operational height prior to filling the first elongate chamber with the water.

4. The deployable seawall system of claim 3, wherein the gas inlet is configured as a dual-purpose port that receives the lifting gas prior to filling and receives the water during filling.

5. The deployable seawall system of claim 1, wherein the vent comprises a controllable valve having a pressure relief function.

6. The deployable seawall system of claim 1, wherein the lattice comprises a repeating pattern of triangular cells extending along the length.

7. The deployable seawall system of claim 1, wherein the flexible wall body comprises a reinforced geometric pattern configured to distribute loads and resist tear propagation.

8. The deployable seawall system of claim 7, wherein the reinforced geometric pattern comprises a hexagonal reinforcement pattern.

9. The deployable seawall system of claim 1, further comprising at least one tether coupled to the flexible wall body and configured to be secured to a ground anchor.

10. The deployable seawall system of claim 1, further comprising a ground-contacting skirt at the bottom region configured to reduce seepage and resist undermining.

11. The deployable seawall system of claim 1, wherein the flexible wall body comprises a reinforced composite sheet including ultra-high-molecular-weight polyethylene fibers or aramid fibers.

12. The deployable seawall system of claim 1, wherein the first elongate chamber and the second elongate chamber are separated by an internal partition.

13. The deployable seawall system of claim 12, wherein the internal partition fluidly isolates the first elongate chamber from the second elongate chamber.

14. The deployable seawall system of claim 12, further comprising an interconnection valve configured to selectively place the first elongate chamber in fluid communication with the second elongate chamber.

15. The deployable seawall system of claim 1, further comprising a plurality of modular segments coupled end-to-end along the length using sealed interfaces.

16. A method of deploying and recovering a seawall, the method comprising:
positioning a flexible wall body along a boundary to be protected, the flexible wall body defining a first chamber and a second chamber;
introducing water into the first chamber and introducing water into the second chamber such that the first chamber and the second chamber are each filled substantially completely with the water to create mass for stability during a severe-water event;
controlling a vent near a top region of the flexible wall body to discharge gas as the water rises within at least one of the first chamber and the second chamber;
maintaining, with intersecting triangular reinforcement members distributed throughout both the first chamber and the second chamber, a hooked crescent forward-facing profile configured to cause an incident wave to curl beneath a forwardly projecting lip portion and roll back on itself and a rearward-facing lower buttress portion extending at about forty-five degrees relative to horizontal; and
after recession of water associated with the severe-water event, evacuating the water from the first chamber and the second chamber and opening the vent to facilitate collapse of the flexible wall body for storage or reuse.

17. The method of claim 16, further comprising, prior to introducing the water into the first chamber, inflating the first chamber with a lifting gas to elevate the flexible wall body toward an operational height.

18. The method of claim 17, wherein introducing the water into the first chamber comprises introducing the water through a port that previously introduced the lifting gas.

19. An in-ground deployable seawall installation comprising:
a subsurface housing defining an elongated cavity;
a flexible wall body storable within the subsurface housing, the flexible wall body defining a first chamber and a second chamber;
at least one pump configured to introduce water into the first chamber and the second chamber such that the first chamber and the second chamber are each fillable substantially completely with the water; and
an activation system configured to initiate deployment responsive to an early warning input indicative of an approaching severe-water event, wherein the flexible wall body includes intersecting triangular reinforcement members distributed throughout both the first chamber and the second chamber, and wherein, in a deployed condition, the flexible wall body defines a hooked crescent forward-facing profile and a rearward-facing lower buttress portion extending at about forty-five degrees relative to horizontal.

20. The in-ground deployable seawall installation of claim 19, further comprising a gas source fluidly coupled to the first chamber and configured to inflate the first chamber to raise the flexible wall body out of the subsurface housing prior to introducing the water.
